(19) United States
(12) Patent Application Publication
(10) Pub. No.: US 2026/0165327 A1
(43) Pub. Date: Jun. 18, 2026

(54) COMPOSITIONS AND METHODS FOR THE MANAGEMENT OF PEST INFECTIONS IN COMPANION ANIMALS

(71) Applicant: CAN TECHNOLOGIES, INC., Wayzata, MN (US)

(72) Inventors: Tristan LIPKIE, Maple Grove, MN (US); Padmakumar B. PILLAI, Germantown, MD (US)

(73) Assignee: CAN TECHNOLOGIES, INC., Wayzata, MN (US)

(21) Appl. No.: 19/124,426

(22) PCT Filed: Oct. 26, 2023
(86) PCT No.: PCT/US2023/077900

§ 371 Date: Apr. 25, 2025

Related U.S. Application Data
(60) Provisional application No. 63/381,357, filed on Oct. 28, 2022.

(51) Int. Cl. A01N 47/02

(52) U.S. Cl. CPC A01N 47/02

(57) ABSTRACT

The present disclosure provides a method for reducing, preventing, or controlling a parasitic infection or infestation in a companion animal The method includes providing an animal feed comprising a pest control agent and administering the animal feed to one or more companion animals for from 1 to 20 days during an infection or infestation. The method can include where the pest control agent comprises a neem extract rich in azadirachtin A, and where the concentration of azadirachtin A administered to the companion animals through the animal feed can include from 0.01 mg to 5 mg azadirachtin A per kg body weight per day. Other aspects are also included herein.

### CROSS-REFERENCE TO RELATED APPLICATIONS

This application claims the benefit of U.S. Provisional Application No. 63/381,357, filed Oct. 28, 2022, and entitled “COMPOSITIONS AND METHODS FOR THE MANAGEMENT OF PEST INFECTIONS IN COMPANION ANIMALS,” which is incorporated by reference herein in its entirety.

### FIELD OF THE INVENTION

The present disclosure relates to compositions and methods for reducing, preventing, or controlling pest infections or infestations in companion animals. In particular, the disclosure provides compositions and methods for reducing, preventing, or controlling pest infections or infestations by administering one or more pest control agents as in-feed or supplementary compositions to various types of companion animals.

### BACKGROUND

Parasitic infections and infestations in companion animals can affect the animals' long-term health and welfare if left uncontrolled. The most prevalent parasites that cause harm to companion animals include various arthropods commonly referred to as fleas, ticks, mites, worms, flies, or lice. These parasites can themselves cause disease or can act as vectors for microbial disease transmission in companion animals. It is of great importance to mitigate the negative effects of such pests in order to protect the animals' health and provide for their wellbeing. It is of further importance to control such pests to eliminate the possibility of zoonotic disease transmission.

Many medicinal agents exist to control parasites in companion animals. These can include topical products or veterinary medicines, including ivermectin or imidacloprid. Many of these types of agents are synthetic in origin. The delivery mechanisms for such agents can present challenges to caregivers and the animals. Injectables can be painful for the animals and can present a unique challenge to companion animal owners due to the unfamiliar handling of syringes and needles, and in calculating dosage requirements for administration. Further, dosing with oral medications can be cumbersome and forgotten by companion animal owners. Additionally, synthetic single molecule medicines can lose efficacy with years of use. Finally, many of the products on the market can lead to adverse reactions in the animals, including vomiting, diarrhea, ataxia, and in severe cases, convulsions. Therefore, a need exists to provide a safe and effective management method that can mitigate various pests that plague companion animals. Such agents should have limited side effects on the health and wellbeing of the animals and should be easy to use and administer by the animal owners.

### SUMMARY

The present disclosure provides method for reducing, preventing, or controlling a parasitic infection or infestation in a companion animal. The method includes providing an animal feed comprising a pest control agent and administering the animal feed to one or more companion animals for from 1 to 20 days during an infection or infestation. The method includes where the pest control agent comprises a neem extract rich in azadirachtin A, and where the concentration of azadirachtin A administered to the companion animals through the animal feed can include from 0.01 mg to 5 mg azadirachtin A per kg body weight per day.

In an aspect, the method further includes where the one or more companion animals include one or more of a cat, a dog, or a horse.

In an aspect, the method further includes where the neem extract rich in azadirachtin A includes from 15 wt. % to 33 wt. % azadirachtin A.

In an aspect, the method further includes where the parasitic infection or infestation is caused by one or more arthropod organisms.

In an aspect, the method further includes where the arthropod organisms comprise one or more fleas, ticks, mites, worms, flies, or lice.

In an aspect, the method further includes where the parasitic infection or infestation is caused by one or more mites including Dermatophagoides farinae, Dermatophagoides pteronyssinus, or Tyrophasugus putrescentia.

In an aspect, the method further includes where the parasitic infection or infestation is caused by the yeast from the genus Malassezia.

In an aspect, the method further includes where the parasitic infection or infestation is caused by one or more species of worms including heartworm, tapeworm, hookworm, and whipworm.

In an aspect, the method further includes where the parasitic infection or infestation is caused by one or more species of fleas including Ctenocephalides canis, Ctenocephalides felis felis, Echidnophaga gallinacean, Pulex irritans, Pulex simulans, Spilopsyllus cuniculi, and Xenopsylla cheopsis.

In an aspect, the method further includes where the parasitic infection or infestation is caused by one or more species of lice including Damalinia equi, Haematopinus asini, Felicola subrostrate, Linognathus setosus, Trichodectes canis, and Heterodoxus spiniger.

In an aspect, the method further includes where the parasitic infection or infestation is caused by one or more species of ticks including Amblyomma Americanum, Rhipicephalus sanguineus, Amblyomma maculatum, Dermacentor reticulatus, Dermacentor variabilis, Ixodes holocyclus, Ixodes pacificus, Ixodes ricinus, and Ixodes scapularis.

In an aspect, the method further includes where the concentration of pest control agent is configured to produce an inhibitory effect including one or more of an antiparasitic effect, an antibacterial effect, an antiviral effect, an antifungal effect, or an antiprotozoal effect.

In an aspect, the method further includes where the neem extract rich in azadirachtin A does not comprise neem oil.

In an aspect, the method further includes where the animal feed further includes one or more components selected from the group consisting of: antibiotic agents, antibacterial agents, antifungal agents, antiviral agents, antiparasitic agents, or antiprotozoal agents.

In an aspect, the method further includes where the pest control agent is provided in the animal feed in an amount effective to modulate the behavior of the pests.

In an aspect, the method further includes where modulating the behavior of the pests includes one or more of a change in feeding habits, a change in feeding patterns, a change in appetite, a change in mobility patterns, a change in mating patterns, a change in development, or a change in fertility, as compared to pests found on control animals not fed a pest control agent.

In an aspect, the method further includes where the change in feeding patterns includes a decrease in feeding patterns.

In an aspect, the method further includes where the change in appetite includes a decrease in appetite.

In an aspect, the method further includes where the change in mobility includes a decrease in mobility.

In an aspect, the method further includes where the change in mating patterns includes a decrease in mating patterns.

In an aspect, the method further includes where the change in development includes an inhibition of development.

In an aspect, the method further includes where the change in fertility includes an inhibition of or delay in egg production, an inability to produce viable eggs, or a reduction in the total number of gravid female pests.

In an aspect, the method further includes where the pest control agent is provided in the animal feed in an amount effective to modulate the pests by causing a decrease in the number of viable pests present on the animal or in the animal's habitat as compared to pests found on control animals not fed a pest control agent.

The present disclosure provides a method for reducing, preventing, or controlling a parasitic infection or infestation in a companion animal. The method can include providing a pest control agent composition including a pest control agent comprising neem extract rich in azadirachtin A and administering the pest control agent composition to one or more companion animals for from 1 to 20 days during an infection or infestation. The method further can include where the concentration of azadirachtin A administered to the companion animals through the pest control agent composition is from 0.01 mg to 5 mg azadirachtin A per kg body weight per day.

In an aspect, the method further includes where the pest control agent composition includes a veterinary medicinal product.

In an aspect, the method further includes where the pest control agent composition includes a dietary supplement.

In an aspect, the method further includes where administering the pest control agent includes administering the pest control agent from once a day to three times per day.

In an aspect, the method further includes where the pest control agent composition is administered to the animal for 14 days.

In an aspect, the method further includes where the one or more companion animals include one or more of a cat, a dog, or a horse.

In an aspect, the method further includes where the neem extract rich in azadirachtin A includes from 15 wt. % to 33 wt. % azadirachtin A.

The present disclosure provides a neem extract rich in azadirachtin A for reducing, preventing, or controlling a parasitic infection or infestation in a companion animal by following the steps including providing an animal feed comprising a pest control agent; and administering the animal feed to one or more companion animals for from 1 to 20 days during an infection or infestation. The present disclosure includes where the pest control agent includes a neem extract rich in azadirachtin A; and wherein the concentration of azadirachtin A administered to the companion animals through the animal feed is from 0.01 mg to 5 mg azadirachtin A per kg body weight per day.

### BRIEF DESCRIPTION OF THE FIGURES

Not applicable.

### DETAILED DESCRIPTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

As described above, companion animals are commonly infected with one or more parasitic species of arthropods. These parasites can often cause painful diseases and conditions in the animal, and as such their owners often seek safe and effective control measures. While various chemical agents that target specific pests exist, there are often limitations on using chemical agents, including owner and animal compliance, technical challenges when delivering various dosage forms, and limitations with long-term efficacy. Further, many chemical agents are specific to only one disease, condition, or parasitic species and therefore many different active agents are required to address the myriad of arthropods that cause disease or other medical conditions. Thus, there exists a need to specifically target a wide spectrum of arthropods that infect companion animal species that are highly effective and safe to use across species. The present disclosure provides for compositions and methods for the reduction, prevention, or control of parasitic infections or infestations in companion animals. In various aspects, the present disclosure is directed to companion animals including cats, dogs, and horses. The present disclosure provides for plant-based pest control agents in the compositions herein.

As used herein, the term “infection” can refer to a condition where a pestilent organism, including the various pests defined herein, can invade any internal or external portion of a host organism's body such that the host organism experiences harm, and where the pestilent organism uses components of the host organism to sustain itself, reproduce, or colonize the host organism.

As used herein, the term “infestation” can refer to the presence of an abnormally large number of pests as defined herein, where the pests are concentrated in a region in numbers that can cause damage or disease through infection of a host organism.

As used herein, the term “pest” can refer to any organism that is detrimental to the health, value, or appearance of another organism. The term pest can include, but is not to be limited to, one or more of various parasites including worms, helminths, flukes, fleas, flies, lice, mites, ticks; one or more species of bacteria; one or more viruses; one or more type of fungi; and various protozoa (e.g., amoeba).

As used herein, the term “parasite” can refer to one or more species of ectoparasite or endoparasite. As used herein, the term “endoparasite” can refer to organisms that inhabit one or more internal niches of another organism. For example, an endoparasite can inhabit one or more of the tissues, organs, or systems of a host organism. For example, an endoparasite can inhabit any of the small intestine, large intestine, esophagus, sinuses, blood, bladder, kidneys, stomach, brain, liver, and heart of a host organism. As used herein, the term “ectoparasite” can refer to organisms that inhabit or occupy an external niche of another species. For example, an ectoparasite can inhabit or occupy the surface of a host species. Ectoparasites can inhabit the skin of an animal and mucous membranes of the eyes, nasal cavity, ears, and mouth or any combination thereof. The parasites can include species belonging to the phylum Arthropoda.

As used herein, the term “pest control agent” can refer to an agent for reducing, preventing, or controlling an infection or infestation caused or contributed to by one or more pests. In various aspects, the pest control agents described herein can refer to an agent for reducing, preventing, or controlling an infection or infestation caused by one or more endoparasites or ectoparasites.

### Companion Animals

The animal feeds and pest control agent compositions herein can be suitable for administration to one or more animal species from the groups including dogs, cats, and horses. The animal feeds and pest control agent compositions herein can be administered to animals at any stage of development and any life stage. While the majority of the aspects herein are directed to companion animals including dogs, cats, and horses, it will be appreciated that companion animals can be a broad term intended to encompass many species of animals. By way of example, companion animals can further include animals such as rabbits, mice, rats, hamsters, gerbils, Guinea pigs, chinchilla, and ferrets.

The animal feeds and pest control agent compositions herein can be formulated for use in any suitable species of canine animal and at any life stage. The term “canine” as used herein refers to domesticated doglike animals of the family Canidae, including those raised as companion animals, competition animals, breeding animals, and the like. The animal feeds and pest control agent compositions herein can be formulated for use in any suitable species of dogs and at any life stage. Domestic dogs (Canis familiaris or Canis lupus familiaris) suitable for administration of the animal feeds and pest control agent compositions herein can include, but are not limited to, breeds including Affenpinscher, Afghan Hound, Airedale Terrier, Akita, Alaksan Klee Kai, Alaskan Malamute, American Bulldog, American English Coonhound, American Eskimo, American Foxhound, American Hairless Terrier, American Leopard Hound, American Staffordshire Terrier, American Water Spaniel, Anatolian Shepherd, Appenzuller Sennenhund, Australian Cattle Dog, Australian Kelpie, Australian Shepherd, Australian Stumpy Tail Cattle Dog, Australian Terrier, Azawakh, Bargodo da Terceira, Barbet, Basenji, Basset Fauve de Bretagne, Basset Hound, Bavarian Mountain Scent Hound, Beagle, Bearded Collie, Beauceron, Bedlington Terrier, Belgian Laekenois, Belgian Malinois, Belgian Sheepdog, Belgian Tervuren, Bergamasco Sheepdog, Berger Picard, Bernese Mountain, Bichon Frise, Biewer Terrier, Black and Tan Coonhound, Black Russian Terrier, Bloodhound, Bluetick Coonhound, Boerboel, Bohemian Shephard, Bolognese, Border Collie, Border Terrier, Borzoi, Boston Terrier, Bouvier des Flandres, Boxer, Boykin Spaniel, Bracco Italiano, Braque du Bourbonnais, Braque Francis Pyrenean, Briard, Brittany, Broholmer, Brussels Griffon, Bull Terrier, Bulldog, Bullmastiff, Cairn Terrier, Canaan, Cane Corso, Cardigan Welsh Corgi, Carolina, Catahoula Leopard, Caucasian Shepherd, Cavalier King Charles Spaniel, Central Asian Shepherd, Cesky Terrier, Chesapeake Bay Retriever, Chihuahua, Chinese Crested, Chinese Shar-Pei, Chinook, Chow Chow, Cirneco dell′Etna, Clumber Spaniel, Cocker Spaniel, Collie, Coton de Tulear, Croation Sheepdog, Curly-Coated Retriever, Czechoslovakian Vlcak, Dachshund, Dalmation, Dandie Dinmont Terrier, Danish-Swedish Farmdog, Deutscher Wachtelhund, Doberman Pinscher, Dogo Argentino, Dogue, de Bordeaux, Drentsche Patrijshond, Drever, Dutch Shepherd, English Cocker Spaniel, English Foxhound, English Setter, English Springer Spaniel, English Toy Spaniel, Entlebucher Mountain, Estrela Mountain, Euraiser, Field Spaniel, Finnish Lapphund, Finnish Spitz, Flat-Coated Retriever, French Bulldog, French Spaniel, German Longhaired Pointer, German Pinscher, German Shepherd, German Shorthaired Pointer, German Spitz, German Wirehaired Pointer, Giant Schnauzer, Glen of Imaal Terrier, Golder Retriever, Gordon Setter, Grand Basset Griffon, Vendeen, Great Dane, Great Pyrenees, Greater Swiss Mountain Dog, Greyhound Hamiltonstovare, Hanoverian Scenthound, Harrier, Havanese, Hokkaido, Hovawart, Ibizan Hound, Icelandic Sheepdog, Irish Red and White Setter, Irish Setter, Irish Terrier, Irish Water Spaniel, Irish Wolfhound, Italian Greyhound, Jagdterrier, Japanese Akitainu, Japanese Chin, Japanese Spitz, Japanese Terrier, Jindo, Kai Ken, Karelian Bear, Keeshond, Kerry Blue Terrier, Kishu Ken, Komondor, Kromfohrlander, Kuvasz, Labrador Retriever, Lagotto Romagnolo, Lakeland Terrier, Lancashire Heeler, Lapponian Herder, Leonberger, Lhasa Apso, Lowchen, Maltese, Manchester Terrier (Standard and Toy), Mastiff, Miniature American Shepherd, Miniature Bull Terrier, Miniature Pinscher, Miniature Schnauzer, Mountain Cur, Mudi, Neapolitan Mastiff, Nederlandse Kooikerhondje, Newfoundland, Norfold Terrier, Norrbottenspets, Norwegian Buhund, Norwegian Elkhound, Norwegian Lundehund, Norwich Terrier, Nova Scotia Duck Tolling Retriever, Old English Sheepdog, Otterhound, Papillon, Parson Russell Terrier, Pekingese, Pembroke Welsh Corgi, Perro de Presa Canario, Peruvian Inca Orchid, Petit Basset Griffon Vendeen, Pharaoh Hound, Plott Hound, Pointer, Polish Lowland Sheepdog, Pomeranian, Poodle (Miniature, Standard, and Toy), Porcelaine, Portuguese Podengo, Portuguese Podengo Pequeno, Portuguese Pointer, Portuguese Sheepdog, Portuguese Water, Pudelpointer, Pug, Puli, Pumi, Pyrenean Mastiff, Pyrenean Shepherd, Rafeiro do Alentejo, Rat Terrier, Redbone Coonhound, Rhodesian Ridgeback, Romanian Carpathian Shepherd, Romanian Mioritic Shepherd, Rottweiler, Russel Terrier, Russian Toy, Russian Tsvetnaya Bolonka, Saint Bernard, Saluki, Samoyed, Schapendoes, Schipperke, Scottish Deerhound, Scottish Terrier, Sealyham Terrier, Segugio Italiano, Shetland Sheepdog, Shiba Inu, Shih Tzu, Shikoku, Siberian Husky, Silky Terrier, Skye Terrier, Sloughi, Slovakian Wirehaired Pointer, Slovensky Cuvac, Slovensky Kopov, Small Musterlander, Smooth Fox Terrier, Soft Coated Wheaten Terrier, Spanish Mastiff, Spanish Water, Spinone Italiano, Stabyhoun, Staffordshire Bull Terrier, Standard Schnauzer, Sussex Spaniel, Swedish Lapphund, Swedish Vallhund, Taiwan, Teddy Roosevelt Terrier, Thai Ridgeback, Tibetan Mastiff, Tibetan Spaniel, Tibetan Terrier, Tornjak, Tosa, Toy Fox Terrier, Transylvanian Hound, Treeing Tennessee Brindle, Treeing Walker Coonhound, Vizsla, Volpino Italiano, Weimaraner, Welsh Springer Spaniel, Welsh Terrier, West Highland White Terrier, Wetterhoun, Whippet, Wire Fox Terrier, Wirehaired Pointing Griffon, Wirehaired Vizsla, Working Kelpie, Xoloitzcuintli, Yakutian Laika, and Yorkshire Terrier.

The animal feeds and pest control agent compositions herein can be formulated for use in any suitable species of feline animal and at any suitable life stage. In various aspects, the feeds and pest control agent compositions herein can be formulated for use in any suitable species of feline animal following weaning. The term “feline” as used herein refers to domesticated cat-like animals, including those raised as companion animals, competition animals, breeding animals, and the like. The animal feeds and pest control agent compositions herein can be formulated for use in any suitable species of domestic cats and at any life stage. Domestic cats (Felis catus) suitable for administration of the animal feeds and pest control agent compositions herein can include, but are not limited to, breeds including Abyssinian, American Bobtail, American Curl, American Shorthair, American Wirehair, Balinese, Bengal, British Shorthair, Birman, Bombay, Burmese, Burmilla, Calico, Canadian Sphinx, Chartreux, Chausie, Cornish Rex, Cymric, Devon Rex, Domestic Long Hair, Domestic Medium Hair, Domestic Shorthair, Elf, Egyptian Mau, Exotic Shorthair, Havana, Himalayan, Japanese Bobtail, Javanese, Korat, Kurilian Bobtail, LaPerm, Lykoi, Maine Coon, Manx, Munchkin, Nebelung, Norwegian, Forest, Ocicat, Oriental Short Hair, Persian, Pixie-bob, Ragamuffin, Ragdoll, Russian Blue, Savannah, Scottish Fold, Selkirk Rex, Siamese, Siberian, Singapura, Snowshoe, Somali, Sphynx, Tabby, Tonkinese, Tortoiseshell, Toyger, Turkish Angora, Turkish Van, Tuxedo, York Chocolate, or any mixed breeds thereof.

The animal feeds and pest control agent compositions herein can be formulated for use in any suitable species of equine animal and at any suitable life stage. The term “equine” as used herein refers to domesticated hoofed animals, including those raised as companion animals, competition animals, breeding animals, and the like. The equines can include those at any life stage and those animals including foals, yearlings, mature, and senior animals. Domestic horses (Equus ferus caballus) suitable for administration of the animal feeds and pest control agent compositions herein can include, but are not limited to, breeds including the Akhal-Teke, American Paint, American Quarter, Andalusian, Appaloosa, Arabian, Black Forest, Clydesdale, Draft, Friesian, Hotblood, Icelandic, Miniature, Morgan, Mongolian, Mustang, Pony, Selle Francias, Shetland Pony, Standardbred, Tennessee Thoroughbred, Walker, and Warmblood. It will be appreciated that the donkey and mule can further be included as a companion equine animal for the purposes herein.

### Target Pests

Pests common to companion animals and that are targeted by the pest control agents and animal feeds herein can include various parasites, including those belonging to the phylum Arthropoda. These pests can include any number of species of flea, tick, mite, worm, fly, or louse. In many cases, the Arthropods that infect companion animals can themselves cause disease or can be vectors for various microbes, including bacteria, fungi, or viruses. The pest control agents described herein can reduce, prevent, or control infections or infestations as caused by any of these pests. While some of the pests described are understood to be specific parasites for specific hosts, many of the pests described can infect or infest a more than one species of companion animal and thus are not limited to one specific host.

Fleas susceptible to the pest control agents and feeds herein can include those of the order Siphonaptera. Fleas that infect or infest one or more of the companion animals herein can include, but are not to be limited to, Ctenocephalides canis, Ctenocephalides felis felis, Echidnophaga gallinacean, Pulex irritans, Pulex simulans, Spilopsyllus cuniculi, Tunga penetrans, and Xenopsylla cheopsis. Fleas can cause various diseases in animals, including, but not to be limited to, flea allergy dermatitis, tapeworms, anemia, bartonellosis, rickettsial diseases, and mycoplasmosis.

Ticks susceptible to the pest control agents and feeds herein can include those of the order Ixodida. Ticks that infect or infest one or more of the companion animals herein can include, but are not to be limited to, Amblyomma americanum (i.e., Lone star tick), Amblyomma maculatum, Dermacentor reticulatus (i.e., cow tick or ornate dog/cow tick), Dermacentor variabilis (i.e., wood tick or dog tick), Ixodes holocyclus, Ixodes pacificus, Ixodes ricinus, Ixodes scapularis (i.e., black-legged tick or deer tick) and Rhipicephalus sanguineus (i.e., brown dog tick). It will be appreciated that the genus Rhipicephalus was formerly classified as Boophilus.

A large number of species of mites exist worldwide that can infect or infest various companion animals. Mites suitable for targeting using the pest control agents and feeds herein are generally classified into two orders of arachnids including Acariformes and Parasitformes. Exemplary mites that can infect or infest one or more of the companion animals herein can include, but are not to be limited to, Cheyletiella blakei, Cheyletiella yasguri, Cheyletiella spp., Chorioptes equi, Demodex canis, Demodex cati, Demodex equi, Demodex gatoi, Dermatophagoides farina, Dermatophagoides pteronyssinus, Notoedres cati, Otodectes cynotis, Psoroptes equi, Sarcoptes scabiei, Trombicula alfreddugesi, Trombicula autumnalis, and Tyrophasgus putrescentia. In various aspects, the diseases or infections caused by the mites herein include several types of mange, including canine scabies, feline scabies (i.e., notoedric mange), otodectic mange, cheyletiellosis, and trombiculosis. In a specific aspect, the parasitic infection or infestation is caused by one or more mites including Dermatophagoides farinae, Dermatophagoides pteronyssinus, or Tyrophasugus putrescentia.

Parasitic worms are a common problem that infect companion animals throughout the world. Worms susceptible to the pest control agents herein can include, but are not to be limited to, those commonly known as heartworm, tapeworm, hookworm, pinworms, threadworms, round worms, and whipworm. Various species of parasitic worms that can infect or infest one or more of the companion animals herein can include, but are not to be limited to, Ancylostoma caninum, Ancylostoma braziliense, Baylisascaris procyonis, Dictyocaulus arnfieldi, Dipylidium caninum, Dirofilaria immitis, Parascaris equorum, Onchocerca cervcalis, Oxocara canis, Oxyuris equi, Strongyloides westeri, Strongylus vulgaris, Strongylus endentatus, Strongylus equinus, Taenia crassiceps, Taenia serialis, Taenia ovis, Toxascaris canis, Toxascaris leonine, and Uncinaria stenocephala,. Worms that can infect horses can include one or more of the large redworms of the genus Strongyles, small redworms of the genus Cyathostomes, roundworms of the genus Ascarids, pinworms of the genus Oxyuris, threadworms of the genus Strongyloides, tapeworms of the genus Cestodes, lungworms such as Dictyocaulus arnfieldi, and bot larvae of the genus Gastrophilus.

Flies susceptible to the pest control agents and feeds herein can include those of the order Diptera. Flies that can infect or infest one or more of the companion animals herein can include, but are not to be limited to, various species of mosquitoes, midges, sandflies, black flies, horse flies, deer flies, tsetse flies, blow flies, bot flies, louse flies, and the like. Exemplary flies that can infect the animals herein can include one or more of Haematobia irritans irritans (i.e., horn fly), Musca autumnalis (i.e., face fly), Stomoxys calcitrans (i.e., stable fly), deer flies of the genera Chrysops and Diachlorus, and Lipoptena cervi. In various aspects, the pests herein can further refer to flies from the order Diptera.

Lice are generally host-specific pests that do not infect across animal species. Lice that can infect or infest one or more of the companion animals herein can include, but are not to be limited to, Damalinia equi, Haematopinus asini, Felicola subrostrate, Linognathus setosus, Trichodectes canis, and Heterodoxus spiniger.

Fungal pests susceptible to the pest control agents herein can include one or more species of yeast, including one or more species from the genus Malassezia. The species of Malassezia that can infect or infest one or more of the companion animals herein can include, but are not to be limited to, Malassezia. furfur, Malassezia. pachydermatis, Malassezia. sympodialis, Malassezia. globosa, Malassezia. obtusa, Malassezia. restricta, Malassezia. slooffiae, Malassezia. equina, Malassezia. dermatis, Malassezia. japonica, Malassezia. nana, Malassezia. capre, Malassezia. yamatoensis, and M. cuniculi.

### Pest Control Agents

The pest control agents suitable for use in the animal feeds and pest control agent compositions herein can adversely affect the pests that feed off their hosts. It will be appreciated that when a host animal has consumed the pest control agents as a component of their daily diet for a given duration of exposure, it can be transferred to the body of the pest when that pest takes a meal from the host. The pest control agents can include any functional agent or active agent that affects, facilitates, or contributes to the eradication or reduction of a pest infection or pest infestation of an animal or population of animals. Additionally, suitable pest control agents can alleviate or improve one or more of the symptoms associated with a pest infection or pest infestation as a result of reducing, preventing, or controlling an infection or infestation. Pest control agents for use herein can be biologically active to one or more animal pests and for one or more animal species.

It will be appreciated that when the companion animals consume the pest control agents described herein, the pest control agent is systemically distributed throughout the tissues and fluids of the animal. Pests can be exposed to the pest control agents upon ingestion of the pest control agent through the skin, flesh, blood, mucus, mucous membranes, or other tissues of the host organism. Modulation of the pests, such as modulation of the pest behavior and life cycle occur to reduce, prevent, or control the pest infection or infestation in the companion animal. In various aspects, the pests can be repelled or killed by the pest control agents herein. Thus, the pest control agents herein can be provided to the pests in an animal feed or a pest control agent composition in an amount effective to modulate the behavior of the pests.

Modulation of the pests can have many effects on the pest population, including an ultimate reduction in the number of viable pests available to infect or infest the host animal. Modulation of the pests can include a modulation of the mortality of the pests. It will be appreciated that modulation of the mortality in the pests can include a decrease in the number of viable pests present on the animal or in the animal's habitat. Modulation of the pests can further include modulation of pest behavior, including a change in feeding habits, a change in feeding patterns, a change in appetite, a change in mobility patterns, a change in mating patterns, a change in development, a change in fertility, or any combination thereof, as compared to pests found on control animals not fed a pest control agent. The change in feeding patterns can include a decrease in feeding patterns. The change in appetite can include a decrease in appetite. The change in mobility can include a decrease in mobility. The change in mating patterns can include a decrease in mating patterns, which in turn can lead to a decrease in development or production of offspring. The change in development can include an inhibition of development due to an inhibition of the molting process leading to a decrease in development in the pests or a delay in development in the pests. The change in fertility can include an inhibition of or delay in egg production, an inability to produce viable eggs, or a reduction in the total number of gravid female pests.

In various aspects, modulation of the pests can include a change in development of the pests through their life cycle, including modulation of growth or progression through a particular life stage, modulation of growth or progression from one life stage to the next life stage (e.g., modulating molting), modulation of egg production, modulation of fertility, or any combination thereof. Modulation of growth or progression through a particular life stage can include halting the growth of the organism and preventing further physical development including a decrease in size or sexual development. In some aspects, modulation of growth or progression from one life stage to the next life stage can include preventing the pests from transitioning from one life stage to the next by inhibiting the molting process. Modulation of egg production can include decreasing the production of eggs by females, which can further result in a decrease in fertility of the adult females. Modulation of fertility can include decreasing the fertility of both female and male pests.

The animal feeds described herein can include, or be supplemented with, one or more pest control agents. Where an animal feed includes at least two or more different pest control agents, each pest control agent can be individually active (or biologically active) and capable of modulating one or more of the behavior, development, or fertility of a pest. Alternatively, the pest control agents can be a component of a pest control agent composition that can be fed separately to an animal. Each pest control agent can be individually effective against one or more different pests as described herein.

Pest control agents suitable for use in the animal feeds and pest control agent compositions herein can include one or more active agents, including synthetic or natural agents. The one or more synthetic or natural agents can include agents classified as an active pharmaceutical ingredient, a veterinary medicinal product, and the like. In some aspects, the active agent for the pest control agents herein can be obtained from a plant belonging to the genus Azadirachta. The pest control agent can be obtained or extracted from Azadirachta indica—a tree commonly known as the “Neem” tree. Extracts prepared from plants belonging to the genus Azadirachta (e.g., Azadirachta indica) can include potent terpenoid compounds, including one or more azadirachtinoids. The azadirachtinoids include azadirachtin compounds such as azadirachtin A, azadirachtin B, azadirachtin D, azadirachtin E, azadirachtin F, azadirachtin G, azadirachtin H, azadirachtin I, azadirachtin K, and/or other azadirachtin variants. The extracts from plants belonging to the genus Azadirachta can also include many other components in various quantities. In some aspects, the extracts can include additional compounds such as the limonoids salannin, nimbin, deacetylsalinin, and 6-desacetylnimbin. In various aspects, the extracts can further include one or more azadirachtinins.

As used herein, the term “azadirachtin” can refer to the collective term applied to a large group of active compounds and is intended to encompass not only all naturally occurring variants or derivatives of azadirachtin, including but not limited to azadirachtins A, B, D, E, F, G, H, I, K, but also all synthetic variants, fragments, analogues, and derivatives thereof. In this regard, it will be appreciated that any azadirachtin variants, fragments, derivatives, or analogues for use herein should be functional, in that they exhibit at least one inhibitory effect as described.

Azadirachtin can be obtained or extracted from any part of the Azadirachta indica plant including, for example, the leaves, stems, bark, fruit, seeds, or any combinations thereof by one or more extraction processes. Suitable methods of extraction can include techniques that exploit mechanical pressing of neem seeds (i.e., kernels) and the use of non-polar solvents. Various solvent extraction techniques exploiting alcohol or an aqueous extraction process, mechanical pressing, and non-polar extraction methods can be used to produce azadirachtin A-rich pest control agents for use herein and are described in U.S. Pat. Nos. 4,556,562; 5,695,763; and 11,096,404; the contents of which are incorporated herein by reference in their entirety.

For example, azadirachtin can be effectively recovered from the seeds of the Neem tree. An exemplary method to recover azadirachtin from neem seeds can include providing neem seeds, crushing the neem seeds, extracting azadirachtin from the crushed seeds with water, and then extracting azadirachtin from the water by adding a second extraction solvent including a non-aqueous solvent that is not miscible with water and has a higher solubility of azadirachtin than water or a surfactant having a turbidity temperature between 20° C. and 80° C. The concentrated azadirachtin can be recovered from the second extraction solution and shows high activity as an insecticide and parasiticide. Extraction methods employing polar solvents (e.g., water) lead to extracts that are rich in polar components, such as azadirachtin compounds.

In various aspects, the azadirachtin suitable for use herein includes azadirachtin A, which is by its scientific name of dimethyl [2aR-[2aα, 3ß,4ß (1aR*,2S*,3aS*,6aS*,7S*, 7aS*), 4aß,5α, 7aS*,8ß(E),10ß,10aα, 10bß]]-10-(acetyloxy) octahydro-3,5-dihydroxy-4-methyl-8-[(2-methyl-1-oxo-2-butenyl)oxy]-4-(3a,6a,7,7a)-tetrahydro-6α-hydroxy-7a-methyl-2,7-methanofuro [2,3-b]oxireno [e]oxepin-1a (2H)-yl)-1H,7H-naphtho-[1,8-bc: 4,4a-c]difuran-5,10a (8H)-dicarboxylate.

Azadirachtin A is the most abundant of a group of the azadirachtinoids. Azadirachtin A makes up about 80% of the azadirachtinoids in the neem seed kernel. The structural formula of azadirachtin A is:

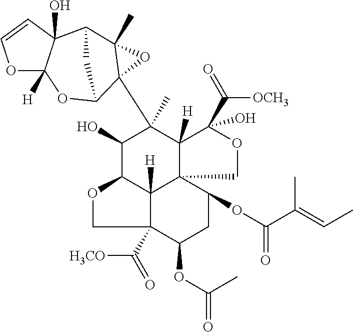

The pest control agents herein can include neem extracts that are an aqueous extract. In various aspects, the neem extract can include an aqueous extract of neem seed. The aqueous extract of neem seed can include an aqueous extract of the neem seed kernel. The aqueous extract of neem seed can include an aqueous extract of the entire neem seed, including the neem seed kernel and the neem seed coating. The aqueous extract of neem seed can be in liquid form, or it can be dried to remove water to create a powder form. By way of example, the neem extracts herein can include an aqueous extract of neem seed or an aqueous extract of neem seed kernel that has been dried into a powder.

It will be appreciated that the pest control agents described herein are not the same thing as neem extracts described as neem oil or solvent-first neem extracts. In various aspects, the pest control agents herein including azadirachtin are richer in the azadirachtinoid active ingredients, and in particular azadirachtin A, than are neem oil and other oil-based formulations. This is due to the fact that azadirachtinoids, such as azadirachtin A, are relatively polar complex terpenoids with a large number of oxygen functionalities, which make the molecules moderately water-soluble (e.g., a solubility of approximately 2 g/L). As a result, azadirachtinoids such as azadirachtin A are present in much higher concentrations in the extracts obtained employing polar solvents than in neem oil or solvent-first neem extracts. Without wishing to be bound by any particular theory, it is believed that the bioavailability of the active ingredients to the target parasite in the water-based extract of azadirachtin A rich extracts of the present disclosure can be greater than in neem oil given the increased solubility and miscibility of the water-based extract in water. Thus, the pest control agents herein do not comprise, consist, or consist essentially of, neem oil. The pest control agent of the animal feed provided herein can comprise, consist, or consist essentially of azadirachtin A.

The pest control agents including neem extract rich in azadirachtin A can include those having from at least 15 wt. % to 33 wt. % azadirachtin A. In various aspects, pest control agents including neem extract rich in azadirachtin A can include those having from at least 20 wt. % to 26 wt. % azadirachtin A. In various aspects, pest control agents including neem extract rich in azadirachtin A can include those having from at least 28 wt. % to 31 wt. % azadirachtin A. In some aspects, pest control agents including neem extract rich in azadirachtin A can include those having from at least 29 wt. % to 30 wt. % azadirachtin A. In other aspects, pest control agents including neem extract rich in azadirachtin A can include those having from at least 34 wt. % to 40 wt. % azadirachtin A. In various aspects, pest control agents rich in azadirachtin A can include those having from 30±1 wt. % azadirachtin A. In various aspects, pest control agents rich in azadirachtin A can include those having from 15 wt. %, 16 wt. %, 17 wt. %, 18 wt. %, 19 wt. %, 20 wt. %, 21 wt. %, 22 wt. %, 23 wt. %, 24 wt. %, 25 wt. %, 26 wt. %, 27 wt. %, 28 wt. %, 29 wt. %, 30 wt. %, 31 wt. %, 32 wt. %, or 33 wt. %, or any amount falling within a range of any of the forgoing. In yet other aspects, pest control agents including neem extract rich in azadirachtin A can include those having from at least 34 wt. % to 45 wt. % azadirachtin A, or at least 38 wt. % to 43 wt. %. As used herein, the terms “neem extract rich in azadirachtin A” and “azadirachtin A-rich composition” can be used interchangeably unless otherwise noted. A composition of an exemplary neem extract rich in azadirachtin A pest control agent suitable for use herein can include the formula as outlined in Table 1.

TABLE 1
Exemplary Azadirachtin-A Rich Pest Control Agent Formulation

| Azadirachtin Composition | % w/w |
|---|---|
| Azadirachtin A | 15-33 |
| Azadirachtin B | ≤19.0 |
| Azadirachtin D | ≤13.0 |
| Azadirachtin E | ≤5.0 |
| Azadirachtin F | ≤5.0 |
| Azadirachtin G | ≤5.0 |
| Azadirachtin H | ≤5.0 |
| Azadirachtin I | ≤5.0 |
| Azadirachtin K and other Azadirachtins | ≤5.0 |
| Total Azadirachtins | 52.0 |

The pest control agent including a neem extract rich in azadirachtin A can further include other azadirachtinoids at various concentrations. The azadirachtinoids can include azadirachtin compounds such as azadirachtin B at from ≤19.0% w/w, or from ≤6.0% w/w, or from 4.0 to 6.0% w/w, or from 5.6% w/w to 6.0% w/w; azadirachtin D at from ≤13.0% w/w, or from ≤5.0% w/w, or from 2.5 to 5.0, or from 4.0% w/w to 5.0% w/w; azadirachtin E at from ≤5.0% w/w, or from 1.0% w/w to 5.0% w/w, or from 1.5% w/w to 2.0% w/w; azadirachtin F at from ≤5.0% w/w, or from 1.0% w/w to 5.0% w/w, or from 1.5% w/w to 2.0% w/w; azadirachtin G at from ≤5.0% w/w, or from 1.0% w/w to 5.0% w/w, or from 1.5% w/w to 2.0% w/w; azadirachtin H at from ≤5.0% w/w, or from 1.0% w/w to 5.0% w/w, or from 2.5% w/w to 4.0% w/w; azadirachtin I at from ≤5.0% w/w, or from 1.0% w/w to 4.0% w/w, or from 1.5% w/w to 2.5% w/w; and azadirachtin K and/or other azadirachtin variants at from ≤5.0% w/w, or from 1.0% w/w to 5.0% w/w, or from 2.5% w/w to 4.0% w/w. The extracts further can include azadirachtinin at from ≤5.0% w/w, or from 1.0% w/w to 5.0% w/w, or from 2.5% w/w to 4.0% w/w.

An exemplary pest control agent suitable for use herein can include an aqueous extract of neem seed that has been dried into a powder. The powder can include the appearance of a fine white powder. The exemplary pest control agent can include azadirachtin A at a concentration of from 17 wt. % to 37 wt. %, azadirachtin B at a concentration of from 0 wt. % to 19 wt. %, and azadirachtin D at a concentration of rom 0 wt. % to 13 wt. %. The exemplary pest control agent further can include trace amounts of other limonoids including nimbin and salannin.

Exemplary pest control agents including azadirachtin A rich compositions include, but are not to be limited to, NeemAzal® (Coromandel, Intl. Ltd., Telangana, India) or NeemAzal® Technical (Coromandel, Intl. Ltd., Telangana, India), or any derivatives of combinations thereof.

### Animal Feeds

The present disclosure provides animal feeds to be used in companion animal diets. It will be appreciated that the animal feeds herein can include suitable types of animal feeds specific for a given animal species. The animal feeds can be used as a component of a diet fed to any species of companion animal identified herein. In various aspects, the animal feeds referred to herein can include a complete and balanced animal feed suitable for and tailored to one or more of canines, felines, or equines. In some aspects, the animal feed is a canine feed. In some aspects, the animal feed is a feline feed. In some aspects, the animal feed is an equine feed.

A complete animal feed can include a nutritionally complete and balanced daily dietary composition that is fed as the sole ration and can maintain life, promote growth, and sustain reproduction without any additional substances being consumed except water. The animal feeds herein can include a complete feed. Complete animal feeds can include mixtures containing appropriate levels of the nutrients required to sustain the life of the animals, including proteins, fats, carbohydrates, and the like. Complete feeds can further include compounded mixtures containing various energy sources such as carbohydrates, proteins, and fats. In various aspects, the animal feeds herein can include at least a protein and a starch. Additional ingredients can be included, such as vitamins and minerals as necessary to support the life, growth, wellbeing, and reproduction of the animals.

The animal feeds herein can be in any suitable form, including a dry solid, a semi-solid, or a liquid. The animal feeds of the present disclosure can be produced using a base feed formulation that uses raw materials that can be chosen based on the application in which it is to be used and for each given animal species. In various aspects, the animal feed is a dry solid feed. In some aspects, the animal feed is a semi-solid feed, where the semi-solid feed includes a liquid component and a solid component. In other aspects, the animal feed is a liquid feed. In yet other aspects, the animal feed can include both a solid feed component and a liquid feed component to be mixed at feeding time. In some aspects, the animal feed can be administered to an animal as a top dress applied to a daily feed ration or meal. In some aspects, the animal feeds can be a liquid, such as a liquid spray, a liquid water additive, a liquid drench, or a liquid water dip bath for application to a base feed. It will be appreciated that the liquid drench as described herein can include one or more of a suspension, a solution, or an emulsion.

Animal feeds in solid form can include pellets, extruded nuggets, steam pellets, flakes, tablets, powders, granules, crumbles, and the like. Animal feeds in liquid form can include pastes, gels, aqueous solutions, oils, oil and water emulsions, slurries, suspensions, and the like. In various aspects, the base feed can include a base feed pellet. In some aspects, the base feed pellet can include a porous matrix distributed throughout. In various aspects, a solid feed, such as a base feed pellet, can further include one or more oils disposed on the surface or distributed throughout the animal feed. The animal feeds can include any substrate that is edible to animals. For example, an edible substrate can provide a source of nutrition to the animal or can be an inert substrate with no nutritive value to the animal.

The animal feeds herein can include one or more pest control agents. In various aspects, the one or more pest control agents can be present in the animal feed in an amount effective to produce an inhibitory effect on one or more pests, as compared to an animal not fed the pest control agents. In various aspects, a solid feed such as a base feed pellet, can further include one or more pest control agents disposed on the surface or distributed throughout the animal feed, such as within an oil disposed within a porous matrix of on an exterior surface of the base feed pellet. In some aspects, the pest control agent can be administered to an animal as a top dress applied to a daily animal feed ration or meal. As such, the animal feeds herein can include pest control agents for controlling infections or infestations caused by one or more pests. In various aspects, the animal feeds herein can include pest control agents for controlling endoparasitic or ectoparasitic infections or infestations.

Each pest control agent included within the animal feeds herein can be individually capable of controlling one or more of a parasitic, bacterial, viral, fungal, or protozoal infection or infestation. Therefore, it should be understood that any given pest control agent for use in all of the aspects herein can be referred to as exhibiting one or more inhibitory effects, including antiparasitic effects (e.g., anti-ectoparasitic, anti-endoparasitic), antibacterial effects, antiviral effects, antifungal effects, or antiprotozoal effects. In various aspects, the pest control agents herein can be referred to as having an inhibitory effect including an antiparasitic effect, where the antiparasitic effect can further include an anti-ectoparasitic effect, an anti-endoparasitic effect, or both, as compared to an animal not fed the pest control agents. It will be appreciated that inhibitory effects against one or more pests can include one or more effects for reducing, preventing, controlling, or minimizing the concentration and spread of the various parasitic, bacterial, viral, fungal, or protozoal organisms, as compared to an animal not fed the pest control agents. In various aspects, a pest control agent of the present disclosure can produce inhibitory effects against one or more pests including one or more effects for reducing, preventing, controlling, or minimizing the concentration and spread of various endoparasites or ectoparasites. Reducing, preventing, or controlling the parasites can include complete prevention of infection or infestation in an animal population or on each animal, a reduction in the total number of parasites present in the animal population or on each animal, or controlling how many parasites are present in the animal population or on each animal according to local regulatory requirements. It will be appreciated that the inhibitory effects described herein can be measured against a population animals infected or infested with one or more pests that are fed a diet lacking the neem extract rich in azadirachtin A.

In other aspects, the inhibitory effect against the pests can include one or more of an anti-feedancy effect, an anti-molting effect, an antifertility and anti-fecundity effect, or an antiparasitic effect. As used herein, “anti-feedancy effect” can refer to an effect exerted by one or more pest control agents that stops or inhibits feeding by the pests resulting in their malnourishment, delayed development, prevention or delay of molting, and death. Malnourished pests are also less likely to efficiently evade host immunity. As used herein, the term “anti-molting” can refer to an effect exerted by one or more pest control agents that prevents or delays the process of molting in the pests. The process of molting occurs as pests grow and shed their exoskeletons from one life stage to the next and is controlled hormonally and neuronally, and the pest control agents herein can exert one or more anti-molting effects against the pests. As used herein, the terms “antifertility effect” and “anti-fecundity effect” are referred to collectively as an “antifertility and anti-fecundity effect” and can include one or more effects on male or female reproduction. It will be appreciated that the term “fertility” can refer to the actual number of offspring born to or eggs released from a female, and the term “fecundity” can refer to the biological potential for reproduction, and due to their close relationship the two terms as used herein can be used interchangeably unless otherwise noted. An antifertility and anti-fecundity effect can include a reduction in total gamete production in males and females, a complete or partial inhibition of viable egg production, a change in the anatomy and morphology of the gametes of males or females, a change in the potential for egg fertilization, and a reduction in the total number of gravid female pests.

In an administered form, the animal feeds herein can include an amount of pest control agent at from about 0.01-100 grams of pest control agent per kilogram animal feed (g/kg), about 90 g/kg animal feed, about 80 g/kg animal feed, about 70 g/kg animal feed, about 60 g/kg animal feed, about 50 g/kg animal feed, about 40 g/kg animal feed, about 30 g/kg animal feed, about 20 g/kg animal feed, about 1-10 g/kg animal feed, about 2-9 g/kg animal feed, about 3-7 g/kg animal feed, about 4-6 g/kg animal feed, or about 5 g/kg animal feed.

In various aspects, the animal feeds herein can include a total amount of pest control agent and/or active ingredient in an amount effective to produce an inhibitory effect against one or more pests, including a concentration from about 0.01 g/kg animal feed, 0.05 g/kg animal feed, 0.1 g/kg animal feed, 0.2 g/kg animal feed, 0.3 g/kg animal feed, 0.4 g/kg animal feed, 0.5 g/kg animal feed, 0.6 g/kg animal feed, 0.7 g/kg animal feed, 0.8 g/kg animal feed, 0.9 g/kg animal feed, 1.0 g/kg animal feed. 1.25 g/kg animal feed, 1.5 g/kg animal feed, 1.75 g/kg animal feed, 2.0 g/kg animal feed, 2.25 g/kg animal feed, 2.5 g/kg animal feed, 2.75, g/kg animal feed, 3.0 g/kg animal feed, 5.0 g/kg animal feed. 5.25 g/kg animal feed, 5.5 g/kg animal feed, 5.75 g/kg animal feed, 6.0 g/kg animal feed, 6.25 g/kg animal feed, 6.5 g/kg animal feed, 6.75, g/kg animal feed, 7.0 g/kg animal feed, 7.0 g/kg animal feed. 7.25 g/kg animal feed, 7.5 g/kg animal feed, 7.75 g/kg animal feed, 8.0 g/kg animal feed, 8.25 g/kg animal feed, 8.5 g/kg animal feed, 8.75, g/kg animal feed, 9.0 g/kg animal feed, 9.25 g/kg animal feed, 9.5 g/kg animal feed, 9.75, g/kg animal feed, 10.0 g/kg animal feed, 15 g/kg animal feed, 20 g/kg animal feed, 25 g/kg animal feed, 30 g/kg animal feed, 35 g/kg animal feed, 40 g/kg animal feed, 45 g/kg animal feed, 50 g/kg animal feed, 55 g/kg animal feed, 60 g/kg animal feed, 65 g/kg animal feed, 70 g/kg animal feed, 75 g/kg animal feed, 80 g/kg animal feed, 85 g/kg animal feed, 90 g/kg animal feed, 95 g/kg animal feed, or 100 g/kg animal feed, or any amount within a range of any of the forgoing concentrations.

It will be appreciated that the aforementioned concentrations equate to an amount from about 0.001-10 weight percent (% w/w) total pest control agent to animal feed. In various aspects, the animal feeds herein can include a total amount of pest control agent including from 0.001% w/w, 0.002% w/w, 0.003% w/w, 0.004% w/w, 0.005% w/w, 0.006% w/w, 0.007% w/w, 0.008% w/w, 0.009% w/w, 0.010% w/w, 0.020% w/w, 0.030% w/w, 0.040% w/w, 0.050% w/w, 0.060% w/w, 0.070% w/w, 0.080% w/w, 0.090% w/w, 0.10% w/w, 0.11% w/w, 0.12% w/w, 0.13% w/w, 0.14% w/w, 0.15% w/w, 0.16% w/w, 0.17% w/w, 0.18% w/w, 0.19% w/w, 0.20% w/w, 0.21% w/w, 0.22% w/w, 0.23% w/w, 0.24% w/w, 0.25% w/w, 0.26% w/w, 0.27% w/w, 0.28% w/w, 0.29% w/w, 0.30% w/w, 0.31% w/w, 0.32% w/w, 0.33% w/w, 0.34% w/w, 0.35% w/w, 0.36% w/w, 0.37% w/w, 0.38% w/w, 0.39% w/w, 0.40% w/w, 0.41% w/w, 0.42% w/w, 0.43% w/w, 0.44% w/w, 0.45% w/w, 0.46% w/w, 0.47% w/w, 0.48% w/w, 0.49% w/w, 0.50% w/w, 0.51% w/w, 0.52% w/w, 0.53% w/w, 0.54% w/w, 0.55% w/w, 0.56% w/w, 0.57% w/w, 0.58% w/w, 0.59% w/w, 0.60% w/w, 0.61% w/w, 0.62% w/w, 0.63% w/w, 0.64% w/w, 0.65% w/w, 0.66% w/w, 0.67% w/w, 0.68% w/w, 0.69% w/w, 0.70% w/w, 0.71% w/w, 0.72% w/w, 0.73% w/w, 0.74% w/w, 0.75% w/w, 0.76% w/w, 0.77% w/w, 0.78% w/w, 0.79% w/w, 0.80% w/w, 0.81% w/w, 0.82% w/w, 0.83% w/w, 0.84% w/w, 0.85% w/w, 0.86% w/w, 0.87% w/w, 0.88% w/w, 0.89% w/w, 0.90% w/w, 0.91% w/w, 0.92% w/w, 0.93% w/w, 0.94% w/w, 0.95% w/w, 0.96% w/w, 0.97% w/w, 0.98% w/w, 0.99% w/w, 1.0% w/w, 2.0% w/w, 3.0% w/w, 4.0% w/w, 5.0% w/w, 6.0% w/w, 7.0% w/w, 8.0% w/w, 9.0% w/w, or 10.0% w/w, or any amount within a range of any of the forgoing values.

The animal feeds can include a number of ingredients that include, but are not to be limited to, meats including poultry such as chicken, turkey, geese, duck, ostrich, quail, and pheasant; beef; buffalo; pork; lamb; venison; fish, including but not limited to whitefish, cod, pollock, salmon, and tuna; crustaceans; liver; or animal byproducts. The animal feeds herein further can include grains such as wheat, rice, oats, soy, other cereals, and flours thereof. The animal feeds compositions can also include various fruits and vegetables, including but not to be limited to, sweet potato, carrot, spinach, potato, pea, pumpkin, beets, squash, green leafy vegetables, apples, berries, and corn. The animal feeds herein further can include seeds or legumes, including, but not to be limited to chickpeas and chickpea flour, black beans, white beans, kidney beans, sunflower seeds, chia seeds and meals, flax seeds and meals, pea and pea flour, soybeans, grain derived glutens sourced from oats, barley, rice, corn, wheat, and the like. The animal feeds further can include various oils and fractions thereof, including but not to be limited to, vegetable oils, sunflower oil, safflower oil, canola oil, soybean oil, olive oil, and coconut oil, and the like. The animal feeds herein further can include herbs, natural and artificial flavors, spices, extracts, glycerin, tapioca starch, soy lecithin, sunflower lecithin, and natural preservatives.

In addition, vitamins and minerals can be added to the animal feeds herein. Exemplary vitamins and minerals can include, but are not to be limited to vitamin A (retinyl-acetate), vitamin D3 (cholecalciferol), vitamin E (DL-α-tocopherol), vitamin K3 (menadione), vitamin B1 (thiamine), vitamin B2 (riboflavin), vitamin B3 (niacin), vitamin B5 (pantothenic acid), vitamin B6 (pyridoxine-HCL), vitamin B7 (biotin), vitamin B9 (folic acid), vitamin B12 (cyanocobalamin)), minerals (e.g., calcium, phosphorus, potassium, sodium, chloride, magnesium, iron, copper, manganese, zinc, iodine, selenium, monocalcium phosphate (CaH₄P₂O₈), sodium bicarbonate (NaHCO₃), sodium chloride (NaCl), potassium chloride (KCl), potassium iodide (KI)) amino acids (e.g., arginine, histidine, isoleucine, leucine, lysine, methionine, methionine-cystine, phenylalanine, phenylalanine-tyrosine, threonine, tryptophan, valine, taurine), ferrous (II) sulfate monohydrate (FeSO₄·H2O); cupric sulfate (CuSO₄·5H₂O); manganese (II) oxide (MnO); MnSO₄·H₂O; zinc sulfate (ZnSO₄·H₂O; Na₂SeO₃), choline chloride (C₅H14ClNO), enzymes, and various combinations thereof. In various aspects, ferrous (II) sulfate monohydrate (FeSO₄·H2O); cupric sulfate (CuSO₄·5H₂O); manganese (II) oxide (MnO); MnSO₄·H₂O; zinc sulfate (ZnSO₄·H₂O; Na₂SeO₃), choline chloride (C₅H₁₄ClNO), enzymes, can be included in chelated mineral forms. By way of example, chelated minerals can include those that are chelated to one or more type of amino acid to facilitate absorption and uptake by the animal.

### Animal Feeds Containing Azadirachtin A

The animal feeds herein can include those that are supplemented with the pest control agent azadirachtin A. The animal feeds can be administered to various companion animals as part of an animal feed diet to control arthropod pests. The animal feeds can be at least partially coated on an exterior surface with an azadirachtin A-rich composition or completely coated on an exterior surface with an azadirachtin A-rich composition. In some aspects, the animal feeds herein can include an azadirachtin A-rich composition that is at least partially dispersed throughout the animal feed. In various aspects, a solid feed such as a base feed pellet, can further include an azadirachtin A-rich composition disposed on the surface or distributed throughout the animal feed, such as within an oil disposed within a porous matrix of on an exterior surface of the base feed pellet. In various aspects, the animal feeds herein can be at least partially coated on an exterior surface with an azadirachtin A-rich composition and further can have an azadirachtin A-rich composition at least partially dispersed throughout the animal feed. In various aspects, the animal feed can include one or more layers of azadirachtin A-rich composition on an exterior surface.

The animal feeds herein can include an azadirachtin A-rich composition at a concentration from about 0.01-100 grams per kilogram (g/kg) animal feed, about 90 g/kg animal feed, about 80 g/kg animal feed, about 70 g/kg animal feed, about 60 g/kg animal feed, about 50 g/kg animal feed, about 40 g/kg animal feed, about 30 g/kg animal feed, about 20 g/kg animal feed, about 0.01-10 g/kg animal feed, about 1-10 g/kg animal feed, about 2-9 g/kg animal feed, about 3-7 g/kg animal feed, about 4-6 g/kg animal feed, or about 5 g/kg animal feed.

In various aspects, the animal feeds herein can include an azadirachtin A-rich composition at a concentration from about 0.01 g azadirachtin A-rich composition per kilogram animal feed (g/kg), 0.05 g/kg animal feed, 0.1 g/kg animal feed, 0.2 g/kg animal feed, 0.3 g/kg animal feed, 0.4 g/kg animal feed, 0.5 g/kg animal feed, 0.6 g/kg animal feed, 0.7 g/kg animal feed, 0.8 g/kg animal feed, 0.9 g/kg animal feed, 1.0 g/kg animal feed. 1.25 g/kg animal feed, 1.5 g/kg animal feed, 1.75 g/kg animal feed, 2.0 g/kg animal feed, 2.25 g/kg animal feed, 2.5 g/kg animal feed, 2.75, g/kg animal feed, 3.0 g/kg animal feed, 5.0 g/kg animal feed. 5.25 g/kg animal feed, 5.5 g/kg animal feed, 5.75 g/kg animal feed, 6.0 g/kg animal feed, 6.25 g/kg animal feed, 6.5 g/kg animal feed, 6.75, g/kg animal feed, 7.0 g/kg animal feed, 7.0 g/kg animal feed. 7.25 g/kg animal feed, 7.5 g/kg animal feed, 7.75 g/kg animal feed, 8.0 g/kg animal feed, 8.25 g/kg animal feed, 8.5 g/kg animal feed, 8.75, g/kg animal feed, 9.0 g/kg animal feed, 9.25 g/kg animal feed, 9.5 g/kg animal feed, 9.75, g/kg animal feed, 10.0 g/kg animal feed, 15 g/kg animal feed, 20 g/kg animal feed, 25 g/kg animal feed, 30 g/kg animal feed, 35 g/kg animal feed, 40 g/kg animal feed, 45 g/kg animal feed, 50 g/kg animal feed, 55 g/kg animal feed, 60 g/kg animal feed, 65 g/kg animal feed, 70 g/kg animal feed, 75 g/kg animal feed, 80 g/kg animal feed, 85 g/kg animal feed, 90 g/kg animal feed, 95 g/kg animal feed, 100 g/kg animal feed, or any amount within a range of any of the forgoing concentrations.

It will be appreciated that the aforementioned azadirachtin A-rich composition concentrations equate to about from 0.001-10 (weight percent) % w/w azadirachtin A-rich composition to animal feed. In various aspects, the animal feeds herein can include an azadirachtin A-rich composition at from 0.001% w/w, 0.002% w/w, 0.003% w/w, 0.004% w/w, 0.005% w/w, 0.006% w/w, 0.007% w/w, 0.008% w/w, 0.009% w/w, 0.010% w/w, 0.020% w/w, 0.030% w/w, 0.040% w/w, 0.050% w/w, 0.060% w/w, 0.070% w/w, 0.080% w/w, 0.090% w/w, 0.10% w/w, 0.11% w/w, 0.12% w/w, 0.13% w/w, 0.14% w/w, 0.15% w/w, 0.16% w/w, 0.17% w/w, 0.18% w/w, 0.19% w/w, 0.20% w/w, 0.21% w/w, 0.22% w/w, 0.23% w/w, 0.24% w/w, 0.25% w/w, 0.26% w/w, 0.27% w/w, 0.28% w/w, 0.29% w/w, 0.30% w/w, 0.31% w/w, 0.32% w/w, 0.33% w/w, 0.34% w/w, 0.35% w/w, 0.36% w/w, 0.37% w/w, 0.38% w/w, 0.39% w/w, 0.40% w/w, 0.41% w/w, 0.42% w/w, 0.43% w/w, 0.44% w/w, 0.45% w/w, 0.46% w/w, 0.47% w/w, 0.48% w/w, 0.49% w/w, 0.50% w/w, 0.51% w/w, 0.52% w/w, 0.53% w/w, 0.54% w/w, 0.55% w/w, 0.56% w/w, 0.57% w/w, 0.58% w/w, 0.59% w/w, 0.60% w/w, 0.61% w/w, 0.62% w/w, 0.63% w/w, 0.64% w/w, 0.65% w/w, 0.66% w/w, 0.67% w/w, 0.68% w/w, 0.69% w/w, 0.70% w/w, 0.71% w/w, 0.72% w/w, 0.73% w/w, 0.74% w/w, 0.75% w/w, 0.76% w/w, 0.77% w/w, 0.78% w/w, 0.79% w/w, 0.80% w/w, 0.81% w/w, 0.82% w/w, 0.83% w/w, 0.84% w/w, 0.85% w/w, 0.86% w/w, 0.87% w/w, 0.88% w/w, 0.89% w/w, 0.90% w/w, 0.91% w/w, 0.92% w/w, 0.93% w/w, 0.94% w/w, 0.95% w/w, 0.96% w/w, 0.97% w/w, 0.98% w/w, 0.99% w/w, 1.0% w/w, 2.0% w/w, 3.0% w/w, 4.0% w/w, 5.0% w/w, 6.0% w/w, 7.0% w/w, 8.0% w/w, 9.0% w/w, or 10.0% w/w (i.e., weight azadirachtin A-rich composition to weight fish feed), or any amount within a range of any of the forgoing values.

Azadirachtins can be relatively unstable in water, however when they are a component of an animal feed, such as dispersed throughout or coated thereon, the azadirachtins, including azadirachtin A, are rendered at least temporarily stable such that they can exhibit their full biological activity during feeding. In addition, it should be noted that azadirachtin A, or any of the neem extract agents of the present disclosure exhibit minimal risk of toxic effects on the companion animals or humans. While arthropods and other invertebrates are sensitive to the active ingredient (i.e., azadirachtin A), higher organisms, including mammals, are unaffected. Furthermore, since azadirachtin A or any neem extract as described herein are readily soluble in water, they do not reside and accumulate in the animals. Rather, once administration has ceased, the pest control agent can quickly lose effectiveness, as it is metabolized, degraded, and/or excreted.

The animal feeds provided herein can include an azadirachtin A-rich composition together with one or more other agents. The one or more or other agents can include anti-ectoparasitic agents, antimicrobial agents (e.g., antibiotic, antibacterial, antifungal, antiviral agents), antiparasitic agents (e.g., anti-endoparasitic agents or anti-ectoparasitic agents), or antiprotozoal agents. The one or more other agents can be mixed with or coated on, or layered within, the animal feed. The one or more other agents can be provided separately (e.g., either in liquid or solid form) and can be administered separately (e.g., before or after) or concurrently with (e.g., during) an animal feed.

### Method of Making an Animal Feed

The disclosure herein provides a method of making an animal feed that contains one or more pest control agents, such as neem extracts including azadirachtin A-rich compositions. The method can include the step of providing a base feed and applying a quantity of pest control agent to a surface of the base feed. A base feed can be formed from various raw materials as described elsewhere herein. For example, the method can include coating the base feed with a quantity of pest control agent. The base feeds can be at least partially coated on an exterior surface with a pest control agent or completely coated on an exterior surface with a pest control agent. In some aspects, the base feeds herein can include a pest control agent that is at least partially dispersed throughout the base feed. In various aspects, the base feeds herein can be at least partially coated with a pest control agent and further can have a pest control agent at least partially dispersed throughout the base feed. In some aspects, the pest control agent can be distributed throughout the base feed, such as throughout a porous matrix of the base feed. In various aspects, the base feed can be coated on an exterior surface with more than one layer of pest control agent, where each layer can include the same pest control agent, or in some aspects each layer can include a different pest control agent.

The pest control agent can be incorporated into or mixed into the base feed by various processes. In various aspects, the base feed can be made using an extrusion process or a pressing process. The pest control agent can be mixed with the base during its manufacture such that it becomes distributed through all or a part of the animal feed. Once the pest control agent has been mixed with the base feed, the base feed and pest control agent mixture can be formed into, for example, pellets, flakes, tablets, powders, or any form as required. In the case of temperature sensitive pest control agents, such pest control agents can be added to a base feed after it has been formed into one of the various forms as indicated. In various aspects, the pest control agent can be sprayed onto a base feed that has already been formed into pellets, flakes, tablets, and the like. For example, the pest control agent can be applied to a base feed as one or more layers or top coatings. In various aspects, the pest control agent can be applied to an outside surface of a pellet or a flake—in this way an animal feed pellet or flake can become wholly or partially coated with the pest control agent. One or more layers or coatings of agent can be applied to an outside surface of an animal feed flake or pellets. Any layer or coating of agent can be “sealed” or protected by the application of one or more additional coatings or layers of a sealing substance. In various aspects, the pest control agent herein can be dispersed in one or more oils or fractions thereof and can be incorporated into a porous matrix within the animal feed.

By way of example, a layer or coating of agent can be sealed by the application of a layer or coating of oil, such as animal fat. In various aspects, one or more further layers or coatings of animal feed can be applied to the (optionally sealed) coating or layer of animal feed. In this way, any given animal feed flake or pellet can include multiple layers of animal feed, sealing substance and/or pest control agent layers. It will be appreciated that the animal feeds described herein can be at least partially coated on an exterior surface with pest control agent. In various aspects, the animal feeds herein can include a pest control agent that is at least partially dispersed throughout the animal feed. In various aspects, the animal feeds herein can include a pest control agent that is at least partially coated with pest control agent and at least partially dispersed throughout the animal feed.

The method for incorporating the pest control agent into the animal feed can include incorporating the pest control agent, such that the final concentration of pest control agent in the animal feed includes from about 0.01 gram pest control agent per kilogram of animal feed (g/kg) to about 1000 g/kg, or from about 0.01 g/kg, 0.1 g/kg, 1 g/kg, 2 g/kg, 3 g/kg, 4 g/kg, 5 g/kg, 6 g/kg, 7 g/kg, 8 g/kg, 9 g/kg or 10 g/kg, 20 g/kg, 30 g/kg, 40 g/kg, 50 g/kg, 60 g/kg, 70 g/kg, 80 g/kg, 90 g/kg, 100 g/kg, 250 g/kg, 500 g/kg, or 750 g/kg, or any amount within a range of any of the forgoing. Concentrations are described herein in more detail in reference to the animal feeds and pest control agent compositions.

The method for incorporating the pest control agent into the animal feed can include determining the final concentration of pest control agent that is incorporated as a part of the animal feed. The determination of the final concentration can include sampling the animal feed using various quantitative analytical methods. By way of example, the animal feed samples can be extracted by a process of overnight protein precipitation in methanol. Following extraction, the sample can be cleaned with Supel™ QUE Z-Sep+ (Sigma Aldrich, St. Louis, Missouri, USA) sorbent, which is a silica gel-based material having active zirconia-based phase, a particle size of approximately 50 μm, and a 70-angstrom (Å) pore size. The resulting extraction solution can be filtered through polytetrafluoroethylene filters having a pore size from 0.2 μm or greater. Analysis of the final concentration of pest control agent in the animal feed samples can be performed using high performance liquid chromatography with ultraviolet detection (HPLC-UV).

The methods herein can include extracting a neem extract rich in azadirachtin A, including those having from at least from 15 wt. % to 33 wt. % azadirachtin A, from at least 28 wt. % to 31 wt. % azadirachtin A, and from at least 29 wt. % to 30 wt. % azadirachtin A.

The method further can include the step of sealing the azadirachtin A-rich composition applied to a surface of the animal feed. The azadirachtin A-rich composition can be sealed by applying a coating of oil or fat to the azadirachtin A-rich composition coated animal feed. Any sealing substance used to seal the azadirachtin A-rich composition can be applied such that it coats all or a part of the azadirachtin A-rich composition coating.

### Pest Control Agent Compositions

The present disclosure further provides a pest control agent composition for administration to companion animals, where the pest control agent composition can include one or more pest control agents. It will be appreciated that the pest control agent compositions are not a complete animal feed and are intended for separate or supplemental administration to a companion animal in addition to an animal feed. The pest control agent compositions can be provided separately for administration before, during, or after administration of the animal feeds. Accordingly, in various aspects, the pest control agent compositions herein can be suitable for use in some aspects as a form of veterinary medicinal product or dietary supplement for reducing, preventing, or controlling pest infections or pest infestations in companion animals. The pest control agent compositions can be administered to the animals at the concentrations described elsewhere herein. For example, the pest control agent compositions herein can be administered at from about 0.01 grams pest control agent per kilogram of animal feed (g/kg) to about 100 g/kg, as described elsewhere herein. In various aspects, the pest control agent composition includes a neem extract rich in azadirachtin A.

The pest control agent composition herein can be in any suitable form, including a dry solid, a semi-solid, or a liquid. In various aspects, the pest control agent composition is a dry solid feed. In some aspects, the pest control agent composition is a semi-solid feed, where the semi-solid feed includes a liquid component and a solid component. In other aspects, the pest control agent composition is a liquid feed. In yet other aspects, the pest control agent composition can include both a solid pest control agent composition component and a liquid pest control agent composition component to be mixed at feeding time.

The pest control agent compositions herein can include azadirachtin extracts rich in azadirachtin A. The pest control agent composition can include a liquid, solid, or semi-solid form, and further can include one or more of an excipient, diluent, carrier, vitamins, minerals, or combinations thereof. In some aspects, the pest control agent compositions can include a treat food given to an animal one a predetermined interval. The predetermined interval can include from 1 day to 30 days. In various aspects, the predetermined interval can be more than 30 days. In various aspects, the pest control agent composition can be administered prophylactically.

The pest control agent compositions can be in the form of a dietary supplement that is provided as any of granules, flakes, pellets, powders, tablets, pills, capsules, cubes, chews, treats, crumbles, pastes, gels, and the like. In various aspects, the pest control agent compositions herein can be formed into many shapes and sizes. In various aspects, the animal feeds herein can be in the shape of a triangle, a square, a rectangle, a sphere, a diamond, a bone, a heart, a pellet, a clover, a flower, a fish, a vegetable, a star, an amorphous shape, and the like. The animal feeds can be formed by a process including one or more of extrusion, retort, cold-pressing, high-pressure processing, and the like.

The pest control agent compositions herein can be included in one or more types of animal feed designed for mixing with another composition, such as a base feed. The pest control agent composition can be in the form of a premix, a concentrate, a base mix, a supplement, a top dress, liquid drench, or a combination thereof.

The pest control agent in the pest control agent compositions herein can include one or more agents for reducing, preventing, or controlling an infection or infestation caused or contributed by one or more endoparasite or ectoparasite pests, including any type of worms, helminths, flukes, lice, mites, ticks, bacteria, viruses, fungi, and protozoa, as described elsewhere. Each pest control agent included in the pest control agent compositions can be individually capable of controlling one or more of a parasitic, bacterial, viral, fungal, or protozoal infections, or infestations. By way of example, the pest control agent compositions herein can include those exhibiting one or more inhibitory effects, including an antiparasitic effect, an antibacterial effect, an antiviral effect, an antifungal effect, an antiprotozoal effect, or any combinations thereof.

A pest control agent composition can be administered before during or after the administration of any of the animal feeds. In some aspects, the pest control agent compositions can be administered with an animal feed that does not contain a pest control agent. In some aspects, the pest control agent compositions can be administered in conjunction with an animal feed that does contain a pest control agent. When used in conjunction with an animal feed that does contain a pest control agent, the separate pest control agent composition can include the same pest control agent as in the animal feed or it can be a different pest control agent than in the animal feed. When used in conjunction with an animal feed that does contain a pest control agent, the separate pest control agent composition can be the same concentration as the pest control agent in the animal feed or it can be a different concentration than the pest control agent in the animal feed. The pest control agent compositions herein can be included in the diet of an animal in the form of a veterinary medicinal product or dietary supplement to any complete and balanced animal feed or can be provided as a component of a complete animal feed.

### Methods of Administration of Pest Control Agents

The pest control agents herein can be administered to one or more companion animals in the animal feeds and pest control agent compositions. Management methods that utilize the pest control agents within animal feeds can be referred to as in-feed agent delivery methods. Thus, the present disclosure provides in-feed agent delivery methods for reducing, preventing, or controlling pests. It will be appreciated that an in-feed agent delivery methods is not a process that applies the pest control agents topically to the target pests. Management methods herein can further utilize pest control agents in a non-feed form such as a veterinary medicinal product or dietary supplement. Thus, the present disclosure further provides veterinary medicinal products or dietary supplements as agents for reducing, preventing, or controlling pests.

The pest control agents that are not included in an animal feed can be administered to the animal in a separate pest control agent composition as a complement to an animal feed, such as in the form of a veterinary medicinal product or a dietary supplement. The animal feed can be administered at the same time or separately from a pest control agent composition. It should be noted that the various pest control agents can be administered to animals that are sick, animals that are infested with parasites, animals that are otherwise healthy in order to prevent parasitic infection, or animals that are less aggressive due to a different infection or condition not associated with a pest infection or infestation. It will be understood that animals that are sick or less aggressive may eat less and therefore may consume lower concentrations of the pest control agent. Thus, management methods that are based on the use of both animal feeds and pest control agent compositions can be particularly useful for managing animals whose appetites are affected by illness, infection, infestation, or being a less aggressive animal that generally eats less animal feed. Moreover, in less aggressive, or low feeding animal, the concurrent use of a pest control agent composition with an animal feed supplemented with a pest control agent can boost or ensure the correct pest control agent concentration is administered to an animal.

The concentration of pest control agent added to an animal feed or the pest control agent compositions herein can be an amount effective to achieve the desired modulation of the behavior, development, or mortality of the pests as discussed elsewhere herein. It will be appreciated that the exact amount of pest control agent to be added to an animal feed or pest control agent compositions can vary depending on, for example, the species of animal, the number of animals to be fed, the extent of the infestation or infection, and the like. Other factors that influence the amount of pest control agent added to the animal feeds or pest control agent compositions include, for example, the presence of possible competitors for the animal feed (i.e., other non-target animal species that can eat the animal feed), the type and species of pest to be controlled, the age and maturity of the pests, the age and maturity of the animal, the season, and the aggressiveness of the animal. It will be appreciated that the concentration of pest control agents added to an animal feed or pest control agent compositions herein can include an amount effective to achieve a desired effect to modulate the behavior and development of the pests, where the amount effective includes one or more concentrations or ranges of concentrations as recited herein. It will be appreciated that the amount effective can be determined by performing a comparison to a control animal or group of animals not fed the pest control agents.

The animal feeds and pest control agent compositions can be formulated such that the concentration of the pest control agent administered to the animal through the animal feed or pest control agent compositions can include an amount effective to produce an inhibitory effect against one or more pests within a range of approximately 0.01-100 mg pest control agent per kg body weight/day (mg/kg/day), 1-90 mg/kg/day, 1-80 mg/kg/day, 1-70 mg/kg/day, 1-60 mg/kg/day, 5-50 mg/kg/day, 10-40 mg/kg/day, 15-35 mg/kg/day, 20-30 mg/kg/day, 0.01-10 mg/kg/day, or 0.01-5 mg/kg/day. It will be appreciated that a range of approximately 0.01-100 mg/kg/day (e.g., mg pest control agent/kg body weight/day) includes at least 0.01 mg/kg/day, 0.02 mg/kg/day, 0.03 mg/kg/day, 0.04 mg/kg/day, 0.05 mg/kg/day, 0.06 mg/kg/day, 0.07 mg/kg/day, 0.08 mg/kg/day, 0.09 mg/kg/day, 0.10 mg/kg/day, 0.20 mg/kg/day, 0.30 mg/kg/day, 0.40 mg/kg/day, 0.50 mg/kg/day, 0.60 mg/kg/day, 0.70 mg/kg/day, 0.80 mg/kg/day, 0.90 mg/kg/day, 1.0 mg/kg/day, 2.0 mg/kg/day, 3.0 mg/kg/day, 4.0 mg/kg/day, 5.0 mg/kg/day, 6.0 mg/kg/day, 7.0 mg/kg/day, 8.0 mg/kg/day, 9.0 mg/kg/day, 10.0 mg/kg/day, 11.0 mg/kg/day, 12.0 mg/kg/day, 13.0 mg/kg/day, 14.0 mg/kg/day, 15.0 mg/kg/day, 16.0 mg/kg/day, 17.0 mg/kg/day, 18.0 mg/kg/day, 19.0 mg/kg/day, 20.0 mg/kg/day, 25.0 mg/kg/day, 30.0 mg/kg/day, 35.0 mg/kg/day, 40.0 mg/kg/day, 45.0 mg/kg/day, 50.0 mg/kg/day, 55.0 mg/kg/day, 60.0 mg/kg/day, 65.0 mg/kg/day, 70.0 mg/kg/day, 75.0 mg/kg/day, 80.0 mg/kg/day, 85.0 mg/kg/day, 90.0 mg/kg/day, 95.0 mg/kg/day, or 100.0 mg/kg/day, or any amount within a range of any of the forgoing values. Any of the aforementioned amounts effective to produce an inhibitory effect can be utilized in the concentrations administered as described herein.

An animal feed or pest control agent composition can be administered for as long as required to achieve the desired inhibitory effect. For example, the pest control agent composition or animal feed can be administered over about a 1 to 20 days, or about 14-18 days. It will be appreciated that, the pest control agent composition, the animal feed, or both, can be administered for consecutive days for 10 days, 11 days, 12 days, 13 days, 14 days, 15 days, 16 days, 17 days, 18 days, 19 days, or 20 days, or for any number of days falling within a range of any of the forgoing. In various aspects, the pest control agent composition or animal feeds herein can be administered for a longer period of time, such as past 20 days. In various aspects, the pest control agent composition or animal feeds herein can be administered 14 days. It should be understood that the time required for administration of the pest control agent composition or animal feeds herein can be of a variable length in order to target the developmental life stages of the pests present in an animal population, pest control agent concentration, or any combinations thereof. In some aspects, the pest control agents herein could be administered prophylactically in the diet of the companion animals at an amount effective to prevent a pest infection or infestation from taking hold within an animal. It will further be appreciated that the pest control agents herein could be administered prophylactically in the diet for any period of time, such as when the animal is sick, by life stage, or seasonally.

In various management methods, the pest control agents herein can be administered for non-consecutive days, where the pest control agent is administered for a predetermined period of time followed by a rest period, and then administered again for a predetermined period of time and followed by a rest period, and so on. By way of example, in some aspects, the pest control agent can be administered for three out of every 10 days. In other aspects, the pest control agent can be administered for seven out of every 14 days. The method for administering the pest control agent for predetermined period of time followed by a rest period can be repeated for as long as desired or until a pest infection or infestation is reduced, prevented, or controlled. It will be appreciated that the pest control agent can be administered for a predetermined period of time, including from 1 day, 2 days, 3 days, 4 days, 5 days, 6 days, 7 days, 8 days, 9 days, or 10 days out of every 5 days to 30 days of rest in between administration.

During the period of administration, the pest control agent composition or animal feed can be administered as many times per day as required to achieve the inhibitory effect. For example, the pest control agent composition or animal feeds described herein can be administered about 1, 2, 3, 4, 5, 6, 7, 8, 9, 10, or more times a day. In various aspects, the pest control agent composition or animal feed can be administered to the companion animal from one to three times per day. In other aspects, the pest control agent composition or animal feed can be administered to the companion animal from one to two times per day.

Thus, the disclosure herein provides for a method for reducing, preventing, or controlling, a parasitic infection or infestation in a companion animal. The method can include providing an animal feed including a pest control agent including a neem extract rich in azadirachtin A. The method can include administering the animal feed to one or more companion animals for from 1 to 20 days during an infection or infestation. The concentration of azadirachtin A administered to the companion animals through the animal feed is from about 0.01 mg to 5 mg azadirachtin A per kg body weight per day. Various additional concentration are also provided elsewhere herein.

The present disclosure further provides a method for reducing, preventing, or controlling a parasitic infection or infestation in a companion animal, including providing a pest control agent composition including a pest control agent including a neem extract rich in azadirachtin A. The method can include administering the pest control agent composition to one or more companion animals for from 1 to 20 days during an infection or infestation. The concentration of azadirachtin A can be administered to the companion animals through the pest control agent composition a concentration from about 0.01 mg to 5 mg azadirachtin A per kg body weight per day. Various additional concentrations are also provided elsewhere herein.

It should be understood that the definitions described herein apply to all aspects as described unless otherwise stated.

In this document, the terms “a,” “an,” or “the” are used to include one or more than one unless the context clearly dictates otherwise. The term “or” is used to refer to a nonexclusive “or” unless otherwise indicated. All publications, patents, and patent documents referred to in this document are incorporated by reference herein in their entirety, as though individually incorporated by reference. In the event of inconsistent usages between this document and those documents so incorporated by reference, the usage in the incorporated reference is to be considered supplementary to that of this document; for irreconcilable inconsistencies, the usage in this document controls.

Values expressed in a range format are to be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” is to be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

Unless expressly stated, ppm (parts per million), percentage, and ratios are on a by weight basis. Percentage on a by weight basis (% w/w or w/w %) is also referred to as weight percent (wt. %) or percent by weight (% wt.) herein.

Exemplary embodiments of the present invention are as follows:

Embodiment 1: A method for reducing, preventing, or controlling a parasitic infection or infestation in a companion animal comprising:
providing an animal feed comprising a pest control agent; and
administering the animal feed to one or more companion animals for from 1 to 20 days during an infection or infestation;
wherein the pest control agent comprises a neem extract rich in azadirachtin A; and
wherein the concentration of azadirachtin A administered to the companion animals through the animal feed is from 0.01 mg to 5 mg azadirachtin A per kg body weight per day.

Embodiment 2: The method of Embodiment 1, wherein the one or more companion animals comprise one or more of a cat, a dog, or a horse.

Embodiment 3: The method of any of Embodiments 1 or 2, wherein the neem extract rich in azadirachtin A comprises from 15 wt. % to 33 wt. % azadirachtin A.

Embodiment 4: The method of any of Embodiments 1-3, wherein the parasitic infection or infestation is caused by one or more arthropod organisms.

Embodiment 5: The method of Embodiment 4, wherein the arthropod organisms comprise one or more fleas, ticks, mites, worms, flies, or lice.

Embodiment 6: The method of any of Embodiments 1-5, wherein the parasitic infection or infestation is caused by one or more mites comprising Dermatophagoides farinae, Dermatophagoides pteronyssinus, or Tyrophasugus putrescentia.

Embodiment 7: The method of any of Embodiments 1-5, wherein the parasitic infection or infestation is caused by a yeast from a genus Malassezia.

Embodiment 8: The method of any of Embodiments 1-5, wherein the parasitic infection or infestation is caused by one or more species of worms comprising heartworm, tapeworm, hookworm, and whipworm.

Embodiment 9: The method of any of Embodiments 1-5, wherein the parasitic infection or infestation is caused by one or more species of fleas comprising Ctenocephalides canis, Ctenocephalides felis felis, Echidnophaga gallinacean, Pulex irritans, Pulex simulans, Spilopsyllus cuniculi, and Xenopsylla cheopsis.

Embodiment 10: The method of any of Embodiments 1-5, wherein the parasitic infection or infestation is caused by one or more species of lice comprising Damalinia equi, Haematopinus asini, Felicola subrostrate, Linognathus setosus, Trichodectes canis, and Heterodoxus spiniger.

Embodiment 11: The method of any of Embodiments 1-5, wherein the parasitic infection or infestation is caused by one or more species of ticks comprising Amblyomma Americanum, Rhipicephalus sanguineus, Amblyomma maculatum, Dermacentor reticulatus, Dermacentor variabilis, Ixodes holocyclus, Ixodes pacificus, Ixodes ricinus, and Ixodes scapularis.

Embodiment 12: The method of any of Embodiments 1-11, wherein the concentration of pest control agent is configured to produce an inhibitory effect comprising one or more of an antiparasitic effect, an antibacterial effect, an antiviral effect, an antifungal effect, or an antiprotozoal effect.

Embodiment 13: The method of any of Embodiments 1-12, wherein the neem extract rich in azadirachtin A does not comprise neem oil.

Embodiment 14: The method of any of Embodiments 1-13, wherein the animal feed further comprises one or more components selected from the group consisting of: antibiotic agents, antibacterial agents, antifungal agents, antiviral agents, antiparasitic agents, or antiprotozoal agents.

Embodiment 15: The method of any of Embodiments 1-14, wherein the pest control agent is provided in the animal feed in an amount effective to modulate a behavior of the pests.

Embodiment 16: The method of Embodiment 15, wherein modulating the behavior of the pests comprises one or more of a change in feeding habits, a change in feeding patterns, a change in appetite, a change in mobility patterns, a change in mating patterns, a change in development, or a change in fertility, as compared to pests found on control animals not fed a pest control agent.

Embodiment 17: The method of Embodiment 16, wherein the change in feeding patterns comprises a decrease in feeding patterns.

Embodiment 18: The method of Embodiment 16, wherein the change in appetite comprises a decrease in appetite.

Embodiment 19: The method of Embodiment 16, wherein the change in mobility comprises a decrease in mobility.

Embodiment 20: The method of Embodiment 16, wherein the change in mating patterns comprises a decrease in mating patterns.

Embodiment 21: The method of Embodiment 16, wherein the change in development comprises an inhibition of development.

Embodiment 22: The method of Embodiment 16, wherein the change in fertility comprises an inhibition of or delay in egg production, an inability to produce viable eggs, or a reduction in the total number of gravid female pests.

Embodiment 23: The method of any of Embodiments 1-22, wherein the pest control agent is provided in the animal feed in an amount effective to modulate the pests by causing a decrease in the number of viable pests present on the animal or in the animal's habitat as compared to pests found on control animals not fed a pest control agent.

Embodiment 24: A method for reducing, preventing, or controlling a parasitic infection or infestation in a companion animal comprising:
providing a pest control agent composition comprising a neem extract rich in azadirachtin A; and
administering the pest control agent composition to one or more companion animals for from 1 to 20 days during an infection or infestation;
wherein the concentration of azadirachtin A administered to the companion animals through the pest control agent composition is from 0.01 mg to 5 mg azadirachtin A per kg body weight per day.

Embodiment 25: The method of Embodiment 24, wherein the pest control agent composition comprises a veterinary medicinal product.

Embodiment 26: The method of Embodiment 24, wherein the pest control agent composition comprises a dietary supplement.

Embodiment 27: The method of any of Embodiments 24-26, wherein administering the pest control agent comprises administering the pest control agent from once a day to three times per day.

Embodiment 28: The method of any of Embodiments 24-27, wherein the pest control agent composition is administered to the animal for 14 days.

Embodiment 29: The method of any of Embodiments 24-28, wherein the one or more companion animals comprise one or more of a cat, a dog, or a horse.

Embodiment 30: The method of any of any of Embodiments 24-29, wherein the neem extract rich in azadirachtin A comprises from 15 wt. % to 33 wt. % azadirachtin A.

Embodiment 31: A neem extract rich in azadirachtin A for reducing, preventing, or controlling a parasitic infection or infestation in a companion animal by following the steps comprising:
providing an animal feed comprising a pest control agent; and
administering the animal feed to one or more companion animals for from 1 to 20 days during an infection or infestation;
wherein the pest control agent comprises a neem extract rich in azadirachtin A; and
wherein the concentration of azadirachtin A administered to the companion animals through the animal feed is from 0.01 mg to 5 mg azadirachtin A per kg body weight per day.

1.-15. (canceled)

16. A method for reducing, preventing, or controlling a parasitic infection or infestation in a companion animal comprising:
providing an animal feed comprising a pest control agent; and
administering the animal feed to one or more companion animals for from 1 to 20 days during an infection or infestation;
wherein the pest control agent comprises a neem extract rich in azadirachtin A; and
wherein the concentration of azadirachtin A administered to the companion animals through the animal feed is from 0.01 mg to 5 mg azadirachtin A per kg body weight per day.

17. The method of claim 16, wherein the one or more companion animals comprise one or more of a cat, a dog, or a horse.

18. The method of claim 16, wherein the neem extract rich in azadirachtin A comprises from 15 wt. % to 33 wt. % azadirachtin A.

19. The method of claim 16, wherein the parasitic infection or infestation is caused by one or more arthropod organisms.

20. The method of claim 19, wherein the arthropod organisms comprise one or more fleas, ticks, mites, worms, flies, or lice.

21. The method of claim 16, wherein the parasitic infection or infestation is caused by one or more mites comprising Dermatophagoides farinae, Dermatophagoides pteronyssinus, or Tyrophasugus putrescentia, or
wherein the parasitic infection or infestation is caused by a yeast from a genus Malassezia, or
wherein the parasitic infection or infestation is caused by one or more species of worms comprising heartworm, tapeworm, hookworm, and whipworm; or
wherein the parasitic infection or infestation is caused by one or more species of fleas comprising Ctenocephalides canis, Ctenocephalides felis felis, Echidnophaga gallinacean, Pulex irritans, Pulex simulans, Spilopsyllus cuniculi, and Xenopsylla cheopsis; or
wherein the parasitic infection or infestation is caused by one or more species of lice comprising Damalinia equi, Haematopinus asini, Felicola subrostrate, Linognathus setosus, Trichodectes canis, and Heterodoxus spiniger; or
wherein the parasitic infection or infestation is caused by one or more species of ticks comprising Amblyomma Americanum, Rhipicephalus sanguineus, Amblyomma maculatum, Dermacentor reticulatus, Dermacentor variabilis, Ixodes holocyclus, Ixodes pacificus, Ixodes ricinus, and Ixodes scapularis.

22. The method of claim 16, wherein the concentration of pest control agent is configured to produce an inhibitory effect comprising one or more of an antiparasitic effect, an antibacterial effect, an antiviral effect, an antifungal effect, or an antiprotozoal effect.

23. The method of claim 16, wherein the neem extract rich in azadirachtin A does not comprise neem oil.

24. The method of claim 16, wherein the animal feed further comprises one or more components selected from the group consisting of: antibiotic agents, antibacterial agents, antifungal agents, antiviral agents, antiparasitic agents, or antiprotozoal agents.

25. The method of claim 16, wherein the pest control agent is provided in the animal feed in an amount effective to modulate a behavior of the pests.

26. The method of 25, wherein modulating the behavior of the pests comprises one or more of a change in feeding habits, a change in feeding patterns, a change in appetite, a change in mobility patterns, a change in mating patterns, a change in development, or a change in fertility, as compared to pests found on control animals not fed a pest control agent.

27. The method of claim 16, wherein the pest control agent is provided in the animal feed in an amount effective to modulate the pests by causing a decrease in the number of viable pests present on the animal or in the animal's habitat as compared to pests found on control animals not fed a pest control agent.

28. A method for reducing, preventing, or controlling a parasitic infection or infestation in a companion animal comprising:
providing a pest control agent composition comprising a neem extract rich in azadirachtin A; and
administering the pest control agent composition to one or more companion animals for from 1 to 20 days during an infection or infestation;
wherein the concentration of azadirachtin A administered to the companion animals through the pest control agent composition is from 0.01 mg to 5 mg azadirachtin A per kg body weight per day.

29. The method of claim 28, wherein the pest control agent composition comprises a veterinary medicinal product.

30. The method of claim 28, wherein the pest control agent composition comprises a dietary supplement.

31. The method of claim 28, wherein administering the pest control agent comprises administering the pest control agent from once a day to three times per day.

32. The method of claim 28, wherein the pest control agent composition is administered to the animal for 14 days.

33. The method of claim 28, wherein the one or more companion animals comprise one or more of a cat, a dog, or a horse.

34. The method of claim 28, wherein the neem extract rich in azadirachtin A comprises from 15 wt. % to 33 wt. % azadirachtin A.

35. A neem extract rich in azadirachtin A for reducing, preventing, or controlling a parasitic infection or infestation in a companion animal by following the steps comprising:
providing an animal feed comprising a pest control agent; and
administering the animal feed to one or more companion animals for from 1 to 20 days during an infection or infestation;
wherein the pest control agent comprises a neem extract rich in azadirachtin A; and
wherein the concentration of azadirachtin A administered to the companion animals through the animal feed is from 0.01 mg to 5 mg azadirachtin A per kg body weight per day.
